(19) United States
(12) Patent Application Publication
(10) Pub. No.: US 2014/0021412 A1
(43) Pub. Date: Jan. 23, 2014

(54) BRICK AND BRICK MANUFACTURING METHOD

(71) Applicants: Mitsuishi Taika Renga Kabushiki Kaisha, (US); DOWA Efutekku Kabushiki Kaisha, (US); DOWA Electronics Kabushiki Kaisha, (US)

(72) Inventors: Hiroyuki Mori, Okayama-ken (JP); Mikio Idei, Okayama-ken (JP); Shigeki Takami, Okayama-ken (JP)

(73) Assignees: MITSUISHI TAIKA RENGA KABUSHIKI KAISHA, Okayama-ken (JP); DOWA ELECTRONICS KABUSHIKI KAISHA, Tokyo-to (JP); DOWA EFUTEKKU KABUSHIKI KAISHA, Okayama-ken (JP)

(21) Appl. No.: 13/743,255

(22) Filed: Jan. 16, 2013

(30) Foreign Application Priority Data
Mar. 19, 2012 (JP) 2012-062079

(51) Int. Cl. G21F 1/06

(52) U.S. Cl. CPC G21F 1/06
USPC 252/478; 264/644

(57) ABSTRACT

To present a brick the density of which is great, that is high strength, and that exhibits a superior radiation shielding effect, and a manufacturing method for this.

A brick in which by firing clay into which ferrite powder has been mixed at a proportion of 60 wt % after being formed into a specified shape, the density after firing has been made 3.5 g/cm³ and the radiation shielding effect has been enhanced is obtained. For the ferrite powder, one that is expressed by the compositional formula: AO·nX₂O₃ (however, it should be noted that in said compositional formula, A is one type or more of an element selected from among Mg, Ca, Mn, Co, Ni, Cu, Sr, Ba, or Pb, X is one type or more of an element selected from among Fe, Co, or Ni, and n is a mol ratio that is defined as an integer from 1 to 9) is used.

### FIELD OF INDUSTRIAL UTILIZATION

The present invention relates to a brick the density of which is great, that is high strength, and that exhibits a superior radiation shielding effect, and a manufacturing method for the brick.

### BACKGROUND OF THE INVENTION

The insufficiency of the temporary storage facilities for the waste materials that have been contaminated with radioactive substances following a nuclear power plant accident has become a problem. It is desirable that temporary storage facilities for waste that has been contaminated with radioactive substances be surrounded by a wall formed with highly dense concrete so as to shield the radiation that is emitted from said waste materials. However, when a wall is to be formed with concrete, it is necessary to go through the series of operations of (1) setting up a form, (2) arranging rebar in the form, (3) pouring the concrete into the form, (4) curing the concrete, and (5) removing the form, and there is a problem that this entails work, time, and cost. In addition, there is the problem that the cold and sterile appearance of the concrete is a blot on the landscape. These problems are one of the reasons that the construction of temporary storage facilities for the waste materials that have been contaminated with radioactive substances has not advanced.

In contrast to this, bricks have advantages such as the fact that construction can be done simply by only laying one on top of another without the need for a form, the appearance after construction is favorable, they exhibit a high degree of strength and have superior earthquake resistance, and the like, and are widely employed as a building material. However, because the density of the ordinary brick is low at around 2.2 g/cm³, a satisfactory radiation shielding effect as an enclosure for the temporary storage facilities described above cannot be expected. For argument's sake, if one were to use bricks and make an enclosure for the temporary storage facilities, it is necessary for the bricks to be stacked in multiple layers or to increase the thickness of each individual brick and, in fact, there is a risk of running into higher costs. It would be advantageous if there were bricks that have a high density and that have a strong radiation shielding effect but that kind of brick is not to be found.

Incidentally, a technology has been proposed to increase the density and raise the radiation shielding effect by having the concrete contain ferrite (for example, refer to Patent References 1 and 2). Ferrite is a kind of magnetic material that contains oxides of iron and is something that is widely used in various kinds of electronic components such as motor magnets, toner drums for copy machines and laser printers, magnetic disks, magnetic tapes, and the like but in the case of the radiation shielding material of Patent References 1 and 2, rather than the magnetic properties that the ferrite possesses, the focus is on the high density (radiation shielding effect). However, nothing is cited in Patent References 1 and 2 regarding having ferrite included in bricks and increasing the radiation shielding effect of the bricks nor is this even suggested. Bricks and concrete have commonality in that both are employed as construction materials but the production methods (in particular, the existence or nonexistence of firing), the materials (composition), the forms, the construction methods, and the like differ and they are completely different things.

In addition, in Patent Reference 3, a brick has been proposed in which a plurality of ceramic materials that contain ferrite have been laminated and fired. However, the brick of Patent Reference 3 is one in which the focus is not on the density possessed by the ferrite but rather on the electromagnetic characteristics the ferrite has and does not go beyond the aim of shielding the electromagnetic waves that are emitted from mobile telephones and personal computers. In other words, nothing is cited in Patent Reference 3 regarding increasing the density of the brick and enhancing the radiation shielding effect nor is this even suggested.

### PRIOR ART REFERENCES

### Patent References

<Patent Reference 1> Japanese Laid-Open Patent Application Publication (Kokai) Number 57-016397

[(page 2, upper right field, lines 8 through 15 and page 2, lower right field, lines 16 through 20)]

<Patent Reference 2> Japanese Laid-Open Patent Application Publication (Kokai) Number 2002-26779

### (Claims)

<Patent Reference 3> Japanese Laid-Open Patent Application Publication (Kokai) Number 2008-094966

(Claims, and paragraphs 0002, 0005, 0030, and 0033)

### SUMMARY OF THE INVENTION

### Problems of Prior Art To Be Solved by the Invention

The present invention is one that was done in order to solve the problems described above and presents a brick the density of which is great, that is high strength, and that exhibits a superior radiation shielding effect. In addition, an object of the present invention is to construct a radiation shielding structure easily and in a short period of time in order to shield radiation and to minimize the construction cost. In addition, an object of the present invention is also to improve the appearance of the radiation shielding structure that has been constructed and to maintain the scenic view of the environs of said radiation shielding structure. Furthermore, an object of the present invention is also to present a manufacturing method for a brick the density of which is great, that is high strength, and that exhibits a superior radiation shielding effect.

### Means To Solve the Problems of Prior Art

The problems described above are solved by presenting a brick the characteristics of which are that the density after firing (bulk density; the same hereafter) is made 3.5 g/cm³ or greater and the radiation shielding effect is enhanced by firing clay into which ferrite powder has been mixed at a proportion of 60 wt % or greater and after forming the clay into a specified shape, and by presenting a manufacturing method for the brick.

By mixing in the ferrite powder and firing in this manner, it is possible to increase the density and provide a brick that exhibits a superior radiation shielding effect. Accordingly, the radiation shielding structures, such as structures for surrounding temporary storage facilities for the waste materials that have been contaminated with radioactive substances and the like, can be constructed easily and in a short period of time merely by laying bricks. In addition, it is possible to obtain bricks that are high in strength. Specifically, in contrast to the strength of bricks that are used in ordinary construction that do not contain ferrite, which is 35 to 50 MPa/cm², the strength of the bricks of the present invention, which contain ferrite powder at a proportion of 60 wt % or more, is 160 to 300 MPa/cm²—about five or six times that of bricks used in ordinary construction. Because of this, it is possible to construct structures that are superior in earthquake resistance. In addition, it is possible for the appearance of the structure that has been constructed to have an ambience and to not be a blot on the landscape. Furthermore, as has already been discussed, ferrite is employed in various kinds of electronic components. Because of this, waste materials that contain ferrite are produced in the manufacturing processes or the disposal process and the ferrite that is collected from the waste materials can be utilized as the raw material for the bricks of the present invention promoting the efficient utilization of the waste material.

The type (the compositional formula) of the ferrite powder in the bricks of the present invention and the manufacturing method for this are not particularly restricted as long as the density of the brick can be made 3.5 g/cm³ or more after firing but usually, the one that is employed is expressed by

compositional formula: AO—nX₂O₃.

However, it should be noted that in the aforementioned compositional formula, n is a mol ratio that is defined as an integer from 1 to 9.

In addition, in the aforementioned compositional formula, A is one type or more element selected from among magnesium (Mg), calcium (Ca), manganese (Mn), cobalt (Co), nickel (Ni), copper (Cu), strontium (Sr), Barium (Ba), or lead (Pb) but, in particular, one type or more of an element selected from among Sr, Ba, or Pb is preferable. This is because the atomic numbers (mass number) of Sr, Ba, and Pb are large compared to other elements and these exhibit a more superior radiation shielding effect.

Furthermore, in the aforementioned compositional formula, X is one type or more of an element selected from among iron (Fe), cobalt (Co), or nickel (Ni) but Fe is particularly preferable. Fe is low cost compared to Co or Ni and is practical.

With regard to the type of clay into which the ferrite powder is mixed in the brick and the manufacturing method for this of the present invention, there are no particular restrictions as long as the clay is something that can be used as the raw material for bricks. For example, a clay that has one type or more of an oxide selected among alumina (Al₂O₃), silica (SiO₂) or boron oxide (B₂O₃) as a primary component is illustrative. Specifically, kaolinite (Al₂Si₂O₅(OH)₄), halloysite (Al₂Si₂O₅(OH)₄·2H₂O), and the like can be given as examples.

In addition, with regard to the brick firing temperature and the brick firing time and the manufacturing method for this of the present invention, these differ depending on the type of clay and of the ferrite powder that is mixed into the clay as well as the balance between the firing temperature and the firing time and the like and there are no particular restrictions. However, when the melting point of the ferrite that is contained in the brick and the strength of the brick are taken into account, the firing temperature of the brick is usually set at 1,000 to 1,400° C. and the firing time is usually set at 50 to 150 hours.

Furthermore, there are no particular restrictions regarding the particle diameter of the ferrite powder in the brick of the present invention and the manufacturing method for this. However, when the ease of ferrite powder manufacture, the ease of mixing the ferrite powder with the clay, and the moldability of the clay after the ferrite powder has been mixed in are taken into account, the particle diameter of the ferrite powder is usually made from 0.5 μm to 8 mm.

### Advantageous Result of the Invention

As discussed above, in accordance with the present invention, it is possible to present a brick the density of which is great, that displays high strength, and that exhibits a superior radiation shielding effect. In addition, a radiation shielding structure for shielding radiation can be constructed easily and in a short period of time and the construction cost can also be minimized. Furthermore, it is possible to improve the appearance of the radiation shielding structure that has been constructed and to maintain the scenic view of the environs of said radiation shielding structure. Moreover, the manufacturing method for a brick the density of which is great, that displays high strength, and that exhibits a superior radiation shielding effect can also be presented.

### PREFERRED EMBODIMENTS OF THE INVENTION

Summary of the brick of the present invention and a manufacturing method for this. A further specific explanation will be given regarding preferred embodiments of the brick of the present invention and of the manufacturing method for this. The brick of the present invention is one that is produced going through

(1) a mixing process in which the ferrite powder is mixed with the clay at a proportion of 60 wt % or more,
(2) a molding process in which the clay into which the ferrite powder has been mixed in the mixing process is formed into a specified shape, and
(3) a firing process in which the clay that has been molded into a specified shape in the molding process is fired.
A brick having a density after firing of 3.5 g/cm³ or more, which is considerably higher than the density of an ordinary brick (around 2.2 g/cm³) and that exhibits a superior radiation shielding effect can be made.

Incidentally, radiation is classified by the propagation form, the wavelength (energy), the generation origin, and the like into particle radiation such as alpha (α) rays, beta (β) rays, neutron rays, and the like, and electromagnetic waves such as gamma (γ) rays, X rays, and the like. With the brick of the present invention it is possible to shield all of the radiation given above but among these, shielding of γ rays and X rays, which have strong penetrability, has been assumed. Because γ rays and X rays do not have an electrical charge and are electrically neutral, it is not possible to attenuate them by means of electromagnetic interaction. For the shielding of γ rays and X rays, the use of a high density material is essential and the brick of the present invention can exhibit a superior effect with regard to shielding γ rays and X rays.

Detailed explanations will be given below regarding the preferred embodiments of the brick of the present invention and of the manufacturing method for this in the order of the processes described above.

1. Mixing Process

The mixing process is a process in which the ferrite powder is mixed into the clay. In the present preferred embodiment, for the ferrite powder, an item that has been crushed and pulverized after mixing iron oxide (Fe₂O₃) and various kinds of additives with such materials as strontium carbonate (SrCO₃), barium carbonate (BaCO₃), and the like and granulating and firing, is used. In addition, ball clay, which is a type of kaolinite is used.

The mixture proportion of the ferrite powder is not particularly limited as long as the proportion is 60 wt % or more. However, when increasing the density of the bricks that are obtained and enhancing their radiation shielding effect as well as raising the density of the bricks are taken into account, it is preferable that the mixture proportion of the ferrite powder be made as high as possible. Specifically, a mixture proportion for the ferrite powder of 70 wt % or more is preferable, 80 wt % or more is more preferable, and 85 wt % or more is even more preferable. On the other hand, if the ferrite powder mixture proportion is made too high, the mixture proportion of the clay inevitably becomes low, the plasticity of the brick in an unfired state is degraded, and it becomes difficult to form said brick into the specified shape. Because of this, the mixture proportion of the ferrite powder is made 97 wt % or less. For the mixture proportion of the ferrite powder, 96 wt % or less is preferable and 95 wt % or less is more preferable.

In addition, the particle diameter of the ferrite powder that is mixed into the clay is, as discussed above, usually made 0.5 μm to 8 mm. However, if the particle diameter of the ferrite powder is too small, time and effort for crushing is required. Because of this, it is preferable that the particle diameter of the ferrite powder be made 1 μm or greater, 2 μm or greater is more preferable, and 3 μm or greater is even more preferable. On the other hand, if the particle diameter of the ferrite powder is too large, there is a risk that molding the clay to which the powder has been added will become difficult. In addition, there is also a chance that it will be difficult to mix the ferrite powder into the clay uniformly. Because of this, it is preferable that the particle diameter of the ferrite powder be made 8 mm or less, 4 mm or less is more preferable, and 2 mm or less is even more preferable. In the present preferred embodiment, the particle diameter of the ferrite powder is made 0.5 to 20 μm with an average value of around 5 gm.

If the waste substances that are obtained when products that contain ferrite (electronic components such as the magnets for motors, toner drums for copy machines and laser printers, magnetic disks, magnetic tape, and the like) are manufactured, or when the waste materials that are produced when said products are disposed of are used for the ferrite powder, the efficient utilization of waste materials can be planned for.

2. Molding Process

When the mixing process described above has finished, the molding process is carried out next. The molding process is a process in which the clay into which the ferrite powder has been mixed in the mixing process is formed into a specified shape. The clay molding method is not particularly restricted but usually, this is carried out using a press machine. If, at this time the pressing is carried out under a vacuum (under reduced pressure; vacuum pressing), the clay will be made dense, the density of the brick after firing will be further increased, and it is possible to obtain a brick that exhibits a more superior radiation shielding effect.

The shape and dimensions that the clay is formed into are suitably determined in conformance with the application of the brick. With regard to the shape that the clay is formed into, examples that can be given include a rectangular parallelepiped (including a cube or a quadrilateral plate), a cylinder (including a disk), a shape that combines these, and the like. In those cases where inserting rebar through the inside of the brick is anticipated, it is possible to form a pass though hole or a groove for threading the rebar at the time that the brick is formed. A design on the brick such as the formation of patterned indentations and the like can be applied to the surface of the clay after molding.

3. Firing Process

When the molding process described above has finished, the firing process is carried out next. The firing process is a process in which the clay that has been formed into a specified shape in the molding process is fired. The firing temperature for the brick is, as discussed above, usually 1,000 to 1,400° C. However, if the firing temperature for the brick is made too low, there is a chance that the brick cannot be satisfactorily fired and the brick will be easily broken after firing. Because of this, it is preferable that the firing temperature for the brick be made 1,100° C. or above and 1,200° C. or above is more preferable. On the other hand, if the firing temperature for the brick is too high, there is a danger that the clay or the ferrite powder that has been mixed into the clay will melt and the brick will not be able to be fired. Because of this, it is preferable that the firing temperature for the brick be made 1,350° C. or below. In the present preferred embodiment, the firing temperature for the brick is made about 1,300° C.

In addition, the firing time for the brick is, as discussed above, usually 50 to 150 hours. However, if the firing time for the brick is too short, there is a chance that the brick cannot be satisfactorily fired and the brick will be easily broken after firing. Because of this, it is preferable that the firing time for the brick be made 60 hours or more. Seventy hours or more is more preferable and 80 hours or more is optimal. On the other hand, if the firing time for the brick is too long, there is a danger that shrinkage due to the firing will be intensified and the dimensional accuracy will be degraded. Because of this, it is preferable that the firing time for the brick be made 120 hours or less and 100 hours or less is more preferable. In the present preferred embodiment, the firing time for the brick (the time from insertion into the firing furnace (tunnel kiln) until removal) is made 96 hours.

4. Completion

When the firing process described above has finished, the brick is completed. The density of the brick after firing is 3.5 g/cm³ and is considerably high compared to that of an ordinary brick. Because of this, the brick of the present invention is one that can exhibit a superior radiation shielding effect compared to an ordinary brick. In addition, the brick of the present invention has a high degree of strength compared to an ordinary brick.

It is preferable that the density of the brick after firing be made as high as possible in order to further increase the radiation shielding effect and the strength of the brick that is obtained. Specifically, it is preferable that the density of the brick after firing be 3.8 g/cm³ or more, 4.0 g/cm³ or more is more preferable, 4.2 g/cm³ or more is even more preferable, and 4.3 g/cm³ or more is optimal. In the brick of Working Example 1 discussed later, the density after firing is made about 4.20 g/cm³. If a scheme such as the vacuum press discussed above is applied to the molding of the brick, it is possible to make the density greater than this (for example, 4.5 g/cm³ or more). On the other hand, the upper limit of the density of the brick after firing is not particularly limited but barring the mixing of a material having a greater density than ferrite powder into the brick, making the density greater than the density of ferrite powder (usually, around 4.6 to 5.1 g/cm³) is not possible.

### Working Examples

5. Evaluation of the Radiation Shielding Effectiveness

The bricks of Working Examples 1 through 3 and the bricks of Comparative Examples 1 through 4 were fabricated in order to investigate the radiation shielding effect of the brick of the present invention and the evaluation of radiation shielding effectiveness was carried out for each of the respective bricks. For the bricks of Working Examples 1 through 3 and of Comparative Examples 1 and 2, strontium·ferrite (SrO·6Fe₂O₃), barium·ferrite (BaO·6Fe₂O₃), ball clay (kaolinite), boric acid (B(OH)₃), N3 (a mixture of crushed fired clay and raw clay, the composition is 64 wt % of silica (SiO₂), 32 wt % of alumina (AL₂O₃), and 2 wt % of iron oxide (III) (Fe₂O₃)), and chromite (FeCr₂O₄) or manganese (Mn) were mixed as shown in Table 1 below. With regard to the bricks of Comparative examples 3 and 4, which are not entered in Table 1 below, the brick of Comparative Example 3 is an ordinary commercially available brick (a brick that does not contain ferrite) and the brick of Comparative Example 4 is a commercially available cement brick (a cement brick that does not contain ferrite). The dimensions of the bricks were made identical in Working Examples 1 through 3 and Comparative Examples 1 through 4 and the thicknesses (the thickness in the direction of the transmission of the radiation) were made uniform at 60 mm. In addition, for reference purposes, the component fractions of the strontium·ferrite in the aforementioned Table 1 are entered in Table 2 below. In Table 2 below, the figures in parentheses indicate that they are an outer percentage. [tn: See http://www.patentde.com/20070419/EP1760049.html for a definition of “outer percentage.” However, there are no figures in parentheses in Table 2.]

TABLE 1

| | W. E. 1 | W. E. 2 | W. E. 3 | C. E. 1 | C. E. 2 |
|---|---|---|---|---|---|
| Strontium•ferrite | 90 | 87 | — | 10 | 25 |
| Barium•ferrite | — | — | 90 | — | — |
| Ball clay | 10 | 10 | 10 | — | — |
| Boric acid | — | 3 | — | — | — |
| N3 | — | — | — | 90 | 75 |
| Chromite | — | — | — | (2) | — |
| Manganese | — | — | — | (1.8) | — |

TABLE 2

| | Content |
|---|---|
| | Percentage |
| Component | (wt %) |
| Fe₂O₃ | 71.8 |
| SiO₂ | 10.4 |
| SrO | 8.93 |
| A1₂O₃ | 6.69 |
| Na₂O | 1.10 |
| MnO | 0.32 |
| TiO₂ | 0.20 |
| BaO | 0.12 |
| K₂O | 0.12 |
| CaO | 0.09 |
| ZrO₂ | 0.07 |
| Cr₂O₃ | 0.04 |
| P₂O₅ | 0.04 |
| SO₃ | 0.03 |
| MgO | 0.02 |
| NiO | 0.02 |
| V₂0₅ | 0.01 |
| Cl | — |

The evaluation of the radiation shielding effect of the bricks of Working Examples 1 through 3 and the bricks of Comparative Examples 1 through 4 was carried out by means of the following method. That is to say, with radiation sensitive film (“X-ray film for industrial use IX100” made by Fuji Film) spread on the bottom of each of the bricks of Working Examples 1 through 3 and the bricks of Comparative Examples 1 through 4, the sensitivity (the depth of black in a monochrome image) after irradiation of the top surface of each brick with radiation for a fixed period of time was measured for each respective film. For the measurement of the depth of the black of the film a densitometer (“Sakura Densitmeter PDA-81” made by Konica Minolta) was used. Two types of radiation, X rays and γ rays were employed. The radiation source for the γ rays was ¹⁹²Ir. Because the greater the radiation shielding effect of the brick, the smaller the amount of radiation that reaches the film and there is no sensing (change in color from white to black) by the film, the figure for the depth that was measured by the previously mentioned densitometer is small. The bulk densities for the bricks of Working Examples 1 through 3 and the bricks of Comparative Examples 1 through 4 and the figures of the depth for the films when each of these bricks was irradiated with X rays and γ rays respectively are shown in Table 3 below.

TABLE 3

| | Bulk | | |
|---|---|---|---|
| | Density | Film Depth After | Film Depth After |
| | (g/cm³) | X Ray Irradiation | γ Ray Irradiation |
| Working example 1 | 4.20 | 0.7 | 0.9 |
| Working example 2 | 4.16 | 0.6 | 0.8 |
| Working example 3 | 4.23 | 0.4 | 0.8 |
| Comparative example 1 | 2.3 | 3.8 | 1.5 |
| Comparative example 2 | 2.6 | 2.8 | 1.5 |
| Comparative example 3 | 2.1 | 4.5 | 1.7 |
| Comparative example 4 | 2.0 | 4.5 | 1.7 |

However, it should be noted that the value for the film depth in the aforementioned Table 3 is the dimensionless quantity D that is calculated using Equation 1 given below. In Equation 1 below, L₀ is the brightness (cd/m²) of the observation light with which the film is irradiated from the observation light irradiation section in the previously mentioned densitometer, and L is the brightness (cd/m²) of the reflected light that the film reflects and that is received by the light receptor section of the previously mentioned densitometer.

Expression 1

D=log₁₀(L₀/L) Equation 1

Looking at the aforementioned Table 3, the film depths in the case where the bricks of Comparative Examples 3 and 4, which do not contain ferrite, were irradiated with X rays were both 4.5 and the film depths in the case of irradiation with γ rays of the bricks in the same Comparative Examples 3 and 4 were both 1.7. On the other hand, although the film depths (2.8 and 3.8) in the case where the bricks of Comparative Examples 1 and 2, which were given a ferrite content of 10 and 25 wt %, were irradiated with X rays were to some degree reduced from that of the film depths (4.5) in the case where the bricks of Comparative Examples 3 and 4, which did not contain ferrite, the film depths (1.5) in the case where the bricks of Comparative Examples 1 and 2 were irradiated with γ rays was almost no reduction from the film depths (1.7) in the case where the bricks of Comparative Examples 3 and 4 were irradiated with γ rays. From this fact, it became clear that although with the bricks of Comparative Examples 1 and 2, which were given a ferrite content of 10 and 25%, a certain shielding effect is ascertained with regard to X rays compared to the bricks of Comparative Examples 3 and 4, which do not contain ferrite, almost no shielding effect is ascertained with regard to γ rays.

In contrast to this, the film depths (0.4 to 0.7) in the case where the bricks of Working Examples 1 through 3, which contain 87 to 90 wt % of ferrite were irradiated with X rays, are a reduction to approximately one-tenth compared to the film depth (4.5) in the case where the bricks of Comparative Examples 3 and 4, which do not contain ferrite, were irradiated with X rays. In addition, the film depths (0.8 to 0.9) in the case where the bricks of Working Examples 1 through 3, which contain 87 to 90 wt % of ferrite were irradiated with γ rays, are a reduction to approximately one-half compared to the film depth (1.7) in the case where the bricks of Comparative Examples 3 and 4, which do not contain ferrite, were irradiated with γ rays. From this fact, it became clear that the bricks of Working Examples 1 through 3, which contain 87 to 90 wt % [sic] of ferrite, exhibit a considerably superior shielding effect compared to the bricks of Comparative Examples 3 and 4 with regard to both X rays and γ rays.

6. Applications

With regard to the bricks of the present invention, there are no particular restrictions concerning their application but, as described above, because they exhibit an extremely superior radiation shielding effect, it is possible for them to be appropriately employed in applications where shielding of radiation is required (the construction of radiation shielding structures). In particular, they can be suitably used in applications that shield radiation having strong penetrating power such as X rays, γ rays, and the like. In addition, because the processing of the bricks of the present invention can be carried out easily and in a short period of time, they can be suitably used in applications for which immediacy is needed. For example, it is possible for them to be suitably employed as bricks used for construction where structures for the enclosure of temporary storage facilities for the waste materials that have been contaminated with radioactive substances are constructed. It is anticipated that by using the bricks of the present invention, the insufficiency of the temporary storage facilities for the waste materials that have been contaminated with radioactive substances following a nuclear power plant accident, which has become a problem, can be resolved.

What is claimed:

1. A brick characterized in that by firing clay into which ferrite powder has been mixed at a proportion of 60 wt % after being formed into a specified shape, the density after firing has been made 3.5 g/cm³and the radiation shielding effect has been enhanced.

2. The brick cited in claim 1 in which the ferrite powder is one that is expressed by the compositional formula: AO·nX₂O₃ (however, it should be noted that in said compositional formula, A is one type or more of an element selected from among Mg, Ca, Mn, Co, Ni, Cu, Sr, Ba, or Pb, X is one type or more of an element selected from among Fe, Co, or Ni, and n is a mol ratio that is defined as an integer from 1 to 9).

3. The brick cited in claim 2 in which A in the previously mentioned compositional formula is one type or more of an element selected from among Sr, Ba, or Pb.

4. The brick cited in claim 2 or 3 in which X in the previously mentioned compositional formula is Fe.

5. The brick cited in any of the claims 1 through 4 in which the clay is one that has one type or more of an oxide selected from among Al₂O₃, SiO₂, or B₂O₃ as a primary component.

6. The brick cited in any of the claims 1 through 5 in which the firing temperature is 1,000 to 1,400° C. and the firing time is 50 to 150 hours.

7. The brick cited in any of the claims 1 through 6 in which the particle diameter of the ferrite powder is 5 μm to 8 mm.

8. A manufacturing method for a brick characterized in that a brick is obtained with which by firing clay into which ferrite powder has been mixed at a proportion of 60 wt % after being formed into a specified shape, the density after firing has been made 3.5 g/cm³ and the radiation shielding effect has been enhanced.
